(19) United States
(12) Patent Application Publication
(10) Pub. No.: US 2009/0115744 A1
(43) Pub. Date: May 7, 2009

(54) ELECTRONIC FREEBOARD WRITING SYSTEM

(75) Inventors: CHARLES C. ZHANG, Teme, AZ (US); Peijian Yuan, Mesa, AZ (US); Belinda Liu, Mesa, AZ (US); Bin Hu, Chandler, AZ (US); Shinhwa Li, Chandler, AZ (US); Jen-Lung David Tai, Scottsdale, AZ (US)

Correspondence Address: MICHAEL WINFIELD GOLTRY, 4000 N. CENTRAL AVENUE, SUITE 1220, PHOENIX, AZ, 85012, US

(73) Assignee: INNOVATIVE MATERIAL SOLUTIONS, INC., GLENDALE, AZ (US)

(21) Appl. No.: 11/935,697

(22) Filed: Nov. 6, 2007

(51) Int. Cl. G06F 3/033

(52) U.S. Cl. 345/179

(57) ABSTRACT

A writing system includes a pen with a two-dimensional optical sensor and a three dimensional acceleration sensor positioned to indicate movement of the pen. A calibrator is coupled to receive path coordinate signals from the two-dimensional optical sensor and the three dimensional acceleration sensor. The calibrator and the two-dimensional optical sensor and the three dimensional acceleration sensor are configured to operate in one of two modes, a contactable mode of operation wherein both the two-dimensional optical sensor and the three dimensional acceleration sensor supply path coordinate signals to the coordinator and a contactless mode of operation wherein only the three dimensional acceleration sensor supplies path coordinate signals to the coordinator.

### FIELD OF THE INVENTION

This invention generally relates to electronic pens and more specifically to electronic pens for writing on any medium.

### BACKGROUND OF THE INVENTION

In the past, a variety of boards have been used for writing, drawing, etc. in the field of lecturing, teaching, etc. Chalk boards eventually evolved into plastic boards requiring special pens with a variety of colored ink or writing liquid. White paper eventually became popular, including large pads in which sheets could be used and removed to provide a clean surface. The white paper evolved into boards that could be written on and copied so that attendees did not have to make copies of the lecturer's illustrations and writings.

Presently, electronic pens are available that can be used to write on special surfaces. Generally, these pens are used to detect or identify handwriting as, for example, for a customer to sign a credit card statement in a commercial enterprise (e.g. a store, bank, etc.). While some of these pens are wireless, they generally require a special surface for the writing function (e.g. blackboard, white board, touch screen, etc.). These pens include a variety of technologies including magnetic sensors, electronic touch screens, optical sensors, infrared, and ultrasound. In addition to requiring special surfaces for writing, many of these devices are cumbersome and expensive. Much of the expense and inconvenience arises because of the necessity for a special writing surface.

In one more current type of pen, an example of which is described in U.S. Pat. No. 6,188,392, entitled “Electronic Pen Device”, issued Feb. 13, 2001, a pressure sensor in the tip of the pen senses when the tip is touching a writing surface and two accelerometers (X and Y axes) sense movement. This type of pen must be held in a particular rotational direction and with a relatively specific tilt angle. If some writing material (e.g. lead, ink, etc.) is included in the tip, the writing surface must be such that it will accept the writing material, otherwise the surface can be substantially any smooth surface that will accommodate the pressure sensor and the marking will only appear on a computer screen.

Another type of pen, an example of which is described in U.S. Pat. No. 6,897,854, entitled “Electronic Pen Input Device and Coordinate Detecting Method Therefore”, issued May 24, 2005, includes a three-axis accelerometer and an optical three-dimensional system including a light radiating and detecting system. While the three-axis accelerometer is used to determine and record movement and position on a writing surface, the optical system is used to determine the orientation of the pen relative to the writing surface. A pressure sensor is also used to determine contact with the writing surface. Thus, the combination of three-axis accelerometer, optical system, and pressure sensor is used to solve many problems prevalent in the previously described pen (two-axis accelerometer). The optical system senses movement of the pen from the writing surface as, for example, the lifting of the pen between words during writing. This pen is only capable of 2-dimensional writing, i.e. the writing must be on a writing surface and the coordinates of the writing, e.g. the start of each line, are strictly determined.

It would be highly advantageous, therefore, to remedy the various problems in the foregoing writing systems and other deficiencies inherent in the prior art.

Accordingly, it is an object of the present invention to provide a new and improved writing system for use in any writing environment.

It is another object of the present invention to provide a new and improved writing system that is capable of being used in conjunction with any information conveying medium including air.

Accordingly, it is an object of the present invention to provide a new and improved writing system that includes a new pen that is highly versatile.

### SUMMARY OF THE INVENTION

The above objects and others are realized in a writing system including a pen with a two-dimensional optical sensor and a three dimensional acceleration sensor positioned to indicate movement of the pen. A calibrator is coupled to receive path coordinate signals from the two-dimensional optical sensor and the three dimensional acceleration sensor. The calibrator and the two-dimensional optical sensor and the three dimensional acceleration sensor are configured to operate in one of two modes, a contactable mode of operation wherein both the two-dimensional optical sensor and the three dimensional acceleration sensor supply path coordinate signals to the coordinator and a contactless mode of operation wherein only the three dimensional acceleration sensor supplies path coordinate signals to the coordinator. Throughout this explanation it should be understood that the term “writing” incorporates any writing, drawing, marking, indicating, pointing, etc. in which the pen is used to convey some information.

The above objects and others are further realized in a method of writing on one of a writing surface and a writing space. The method includes the steps of providing a pen with a two-dimensional optical sensor and a three dimensional acceleration sensor positioned to indicate movement of the pen and a calibrator coupled to receive path coordinate signals from the two-dimensional optical sensor and the three dimensional acceleration sensor. The method further includes a step of coupling the two-dimensional optical sensor, the three dimensional acceleration sensor, and the calibrator into one of a contactable mode of operation in which both the two-dimensional optical sensor and a three dimensional acceleration sensor communicate signals to the calibrator and a contactless mode of operation in which only the three dimensional acceleration sensor communicates signals to the calibrator. The method further includes a step of coupling the two-dimensional optical sensor, the three dimensional acceleration sensor, and the calibrator into an erase mode of operation.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 illustrates an embodiment of a writing system in accordance with the present invention;

FIG. 2 illustrates signal flow of the writing system of FIG. 1;

FIG. 3 is a view of writing surfaces of the writing system of FIG. 1;

FIG. 4 is a perspective view of a pen for use in the writing system of FIG. 1;

FIG. 5 is an enlarged perspective of a portion of the pen of FIG. 4, some internal components illustrated in broken lines for convenience of understanding;

FIG. 6 is a simplified block diagram of the pen of FIG. 4 illustrating the internal components;

FIG. 7 is a simplified block diagram illustrating the connection of the component blocks of FIG. 6;

FIG. 7A is a function diagram illustrating the various functions of the component blocks of FIG. 7;

FIG. 8 is a simplified block diagram of the calibrator of the writing system of FIG. 1;

FIG. 8A is a function diagram illustrating the various functions of the component blocks of FIG. 8;

FIG. 8B is a function diagram illustrating additional functions of the component blocks of FIG. 8;

FIG. 9 is a simplified flow chart illustrating two different functions or modes of the writing system of FIG. 1 for contact writing and contactless writing;

FIGS. 10 a-d illustrate tracking and sensor operation in four different writing situations;

FIG. 11 is a simplified flow chart illustrating a contactless writing mode of the writing system of FIG. 1;

FIG. 12 illustrates calibrator writing links for several different contactless writing functions;

FIG. 13 illustrates a finger holder for the pen of FIG. 4; and

FIG. 14 illustrates the addition of a pen for writing on paper or the like.

### DETAILED DESCRIPTION OF A PREFERRED EMBODIMENT

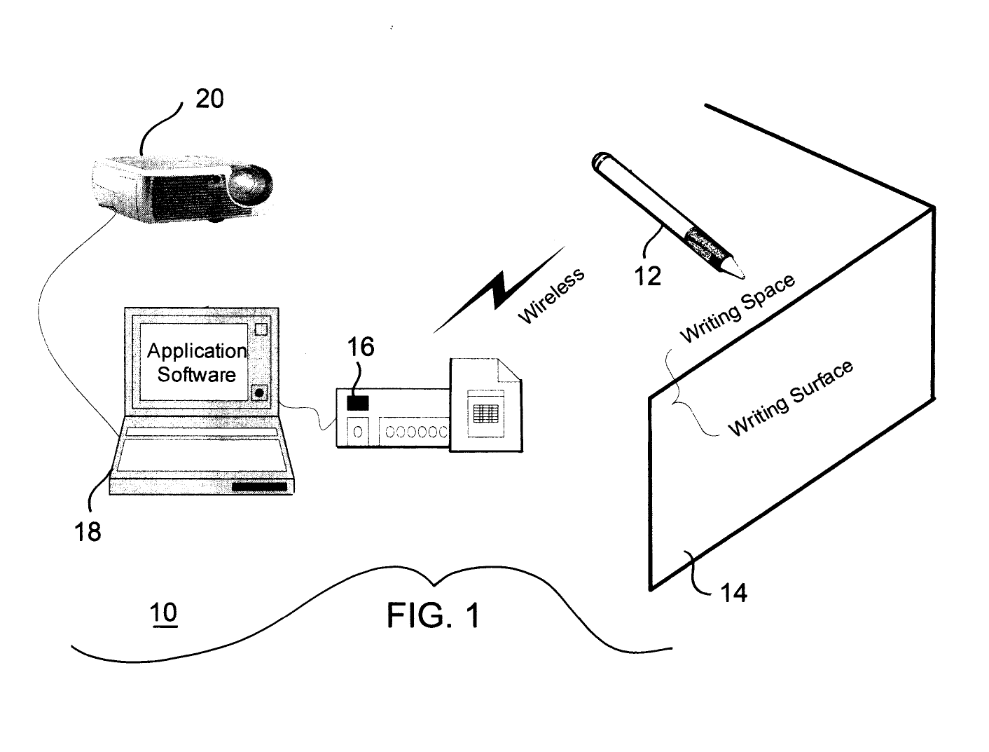

Turning now to the drawings in which similar numbers designate similar components throughout the several views, attention is first directed to FIG. 1 which illustrates an embodiment of a writing system 10 in accordance with the present invention. Writing system 10 includes a pen 12 for use in writing on a writing surface 14, which may be virtually any surface, such as paper, plastic, fabric, fiber, wood, a wall, etc. Pen 12 is also capable of writing in free space (i.e. air), which will be referred to herein as “writing space”. Writing system 10 also includes a calibrator 16 coupled to a computer 18, which is in turn coupled to a projector 20 for illustrating (projecting) the writing on a convenient visible surface, e.g. the writing surface or similar convenient surface. In this context it will be understood that writing pen 12 and calibrator 16 are the main components (i.e. those sold as a writing system) of writing system 10 with computer 18 and projector 20 generally being any equipment available to the purchaser of the writing system. However, for purposes of explaining the complete operation all of the above components are included in the writing system 10. Also, throughout this explanation it should be understood that the term “writing” incorporates any writing, drawing, marking, indicating, pointing, etc. in which pen 12 is used to convey some information.

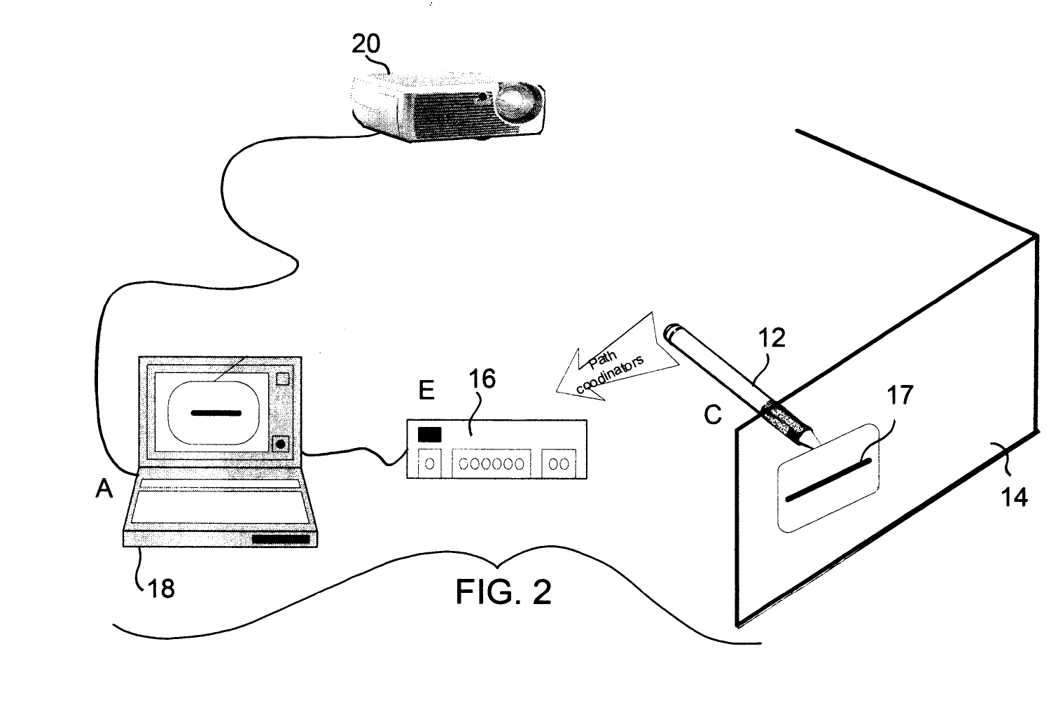

Referring to FIG. 2, a simplified diagram of the interaction of the components or flow of the operation is illustrated. As pen 12 is moved in a writing operation, path coordinates in the form of electrical signals indicative of that moving action are transmitted to calibrator 16. In this preferred embodiment electrical signals are sent by some convenient wireless method, such as Bluetooth, Zigbee, WiFi, RFID, Ultra-Wideband, Z-Wave, etc., however, it will be understood that in some special applications pen 12 may be connected to calibrator 16 by a fine wire or wires, infrared, ultrasound, or other known coupling techniques. Calibrator 16 calculates and stores the display parameters and simultaneously sends the display parameters to computer 18. Computer 18 generates a display, using the display coordinates, and sends the display to projector 20, which projects the display onto writing surface 14 or any other convenient display surface.

A preferred method of calibration of writing system 10 is also illustrated in FIG. 2. In a first step the configuration function is selected in the application software residing in calibrator 16. Initially, projector 20 receives signals from calibrator 16 by way of computer 18 and projects a size for the writing area onto writing surface 14. Also, in response to instructions (or signals) from calibrator 16, projector 20 projects a base line 17 onto writing surface 14. The operator then follows base line 17 with pen 12 and calibrator 16 calculates the display proportion parameters and saves them in memory. The base line signals are also used in calibrator 16 to reduce accumulated errors from the sensors in pen 12, as will be explained below. The initialization is a one time step operation (per writing application) and is used only to make sure the proportion between the writing path and the computer or projector display is correct.

Generally, for purposes of this disclosure, FIG. 1 illustrates writing system 10 in the contactless writing mode (i.e. writing in the writing space) and FIG. 2 illustrates writing system 10 in the contact writing mode (i.e. writing on writing surface 14).

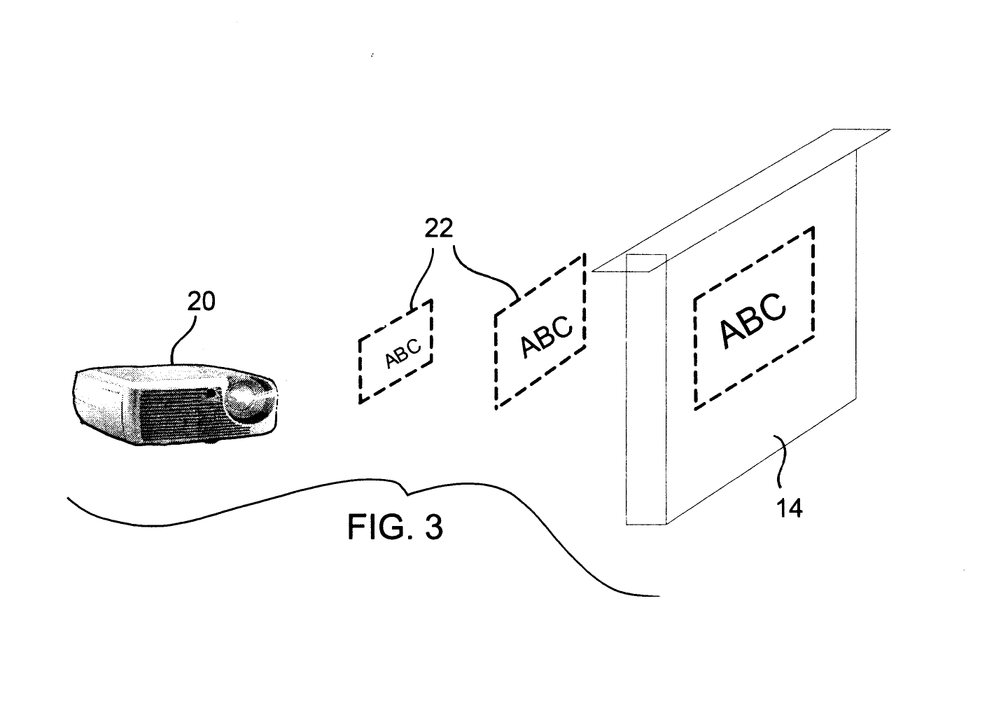

Referring additionally to FIG. 3, writing surface 14 is illustrated along with writing space, designated 22, which can be virtually any size desired. That is, the writing area initially projected by projector 20 during initial calibration is adjustable and can be changed by the operator using adjustments in calibrator 16. In this illustration it will be understood that any writing performed in writing space 22 is converted to display parameters and communicated to projector 20 for display on a selected display surface, such as writing surface 14. That is, any writing performed with pen 12 is converted to path coordinates, sent to calibrator 16 where display parameters are generated and sent to computer 18. Generally, calibrator 16 uses the path coordinates, sent in real time, to update (i.e. compare stored coordinates to new real time coordinates) the stored display proportion parameters. A display of the path is generated and may be sent to projector 20 which can then display the path on writing surface 14, generally in black but it can be in any desired color (except white). An erase mode is also included in writing system 10. In the erase mode the implementation is similar to the write mode except that a white color path is displayed, which essentially removes the original path that the operator desires to erase.

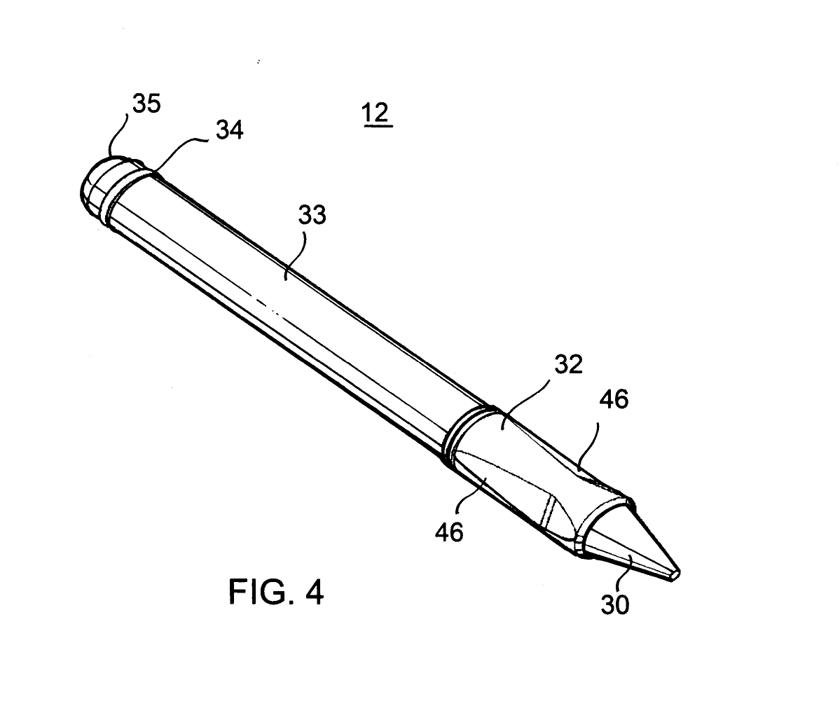

Turning to FIG. 4, a perspective view of a preferred embodiment of pen 12 is illustrated. While a variety of different designs might be devised, the specific design illustrated is selected for its tactility or familiarity relative to other well known writing instruments. In this configuration, pen 12 includes a tip portion 30, a gripping portion 32, an elongated body portion 33, a cycle or function index light ring 34 and an end cap 35.

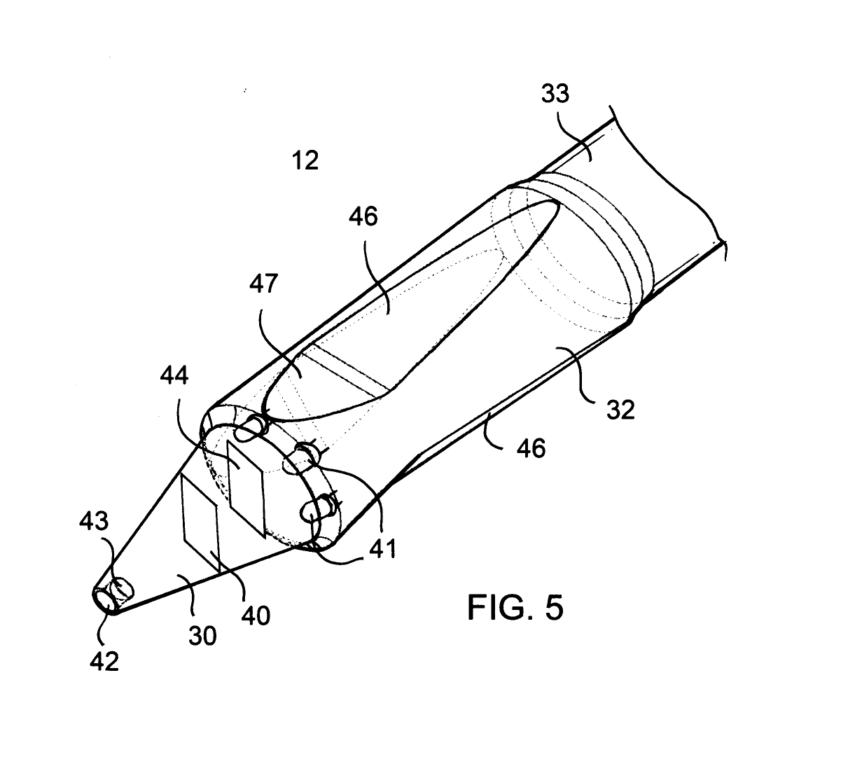

Referring additionally to FIG. 5, an enlarged view of tip portion 30 and gripping portion 32 of pen 12 is illustrated. For convenience of understanding some components within tip portion 30 are illustrated in broken lines. Tip portion 30 is formed with an axially extending opening 42 therethrough for reception of light by a Complementary Metal Oxide Semiconductor (CMOS) motion sensor, illustrated as square 40. CMOS motion sensors are well known in the art (typical examples being the system generally used in a computer mouse) and will not be explained in detail herein except to state that this type of sensor receives light reflected through opening 42 from writing surface 14, which light is focused by a lens 43 and movement is sensed from the reflected light that is focused onto light sensors positioned on square 40. In this embodiment, tip portion 30 is formed of translucent material and ambient light is normally used as the light source. In instances where ambient light is insufficient, one or more LEDs 41 are automatically illuminated to provide the required light for sensing movement. While a CMOS motion sensor is used in this preferred embodiment for its accuracy and simplicity it will be understood that a variety of optical motion sensors could be used.

A second sensor 44 includes a three-axes accelerometer (or three single axis accelerometers) positioned to sense acceleration in the X, Y, and Z axes. The Z axis lies along the longitudinal axis of pen 12, with the X and Y axes being orthogonal and generally in the plane of writing surface 14. It will be understood that the closer sensors 40 and 44 are positioned to the lower end of tip portion 30, the more accurately they can sense motion. Also, because the optical motion sensor receives light that is reflected from writing surface 14, it is situated closest to the end of tip portion 30 and as close to the writing surface as practical.

In this embodiment gripping portion 32 is formed with thumb and finger rests, indentations 46 which add to the tactility as well as better positioning pen 12 for the operation of the three-axes accelerometer sensor 44. In one embodiment the lower end (writing surface engagement end) of tip portion 30 is slanted to aid in positioning pen 12 relative to the writing surface. Also, in this embodiment one or more buttons 47 are conveniently situated in one or more of the indentations 46. Buttons 47, which may include simple push buttons, piezoelectric buttons, etc., provide means for switching to different functions of pen 12, as will be explained in more detail presently. In this preferred embodiment, cap 35 of pen 12 provides the power On/Off function, for example, when cap 35 is depressed power is On and when cap 35 is released power is Off.

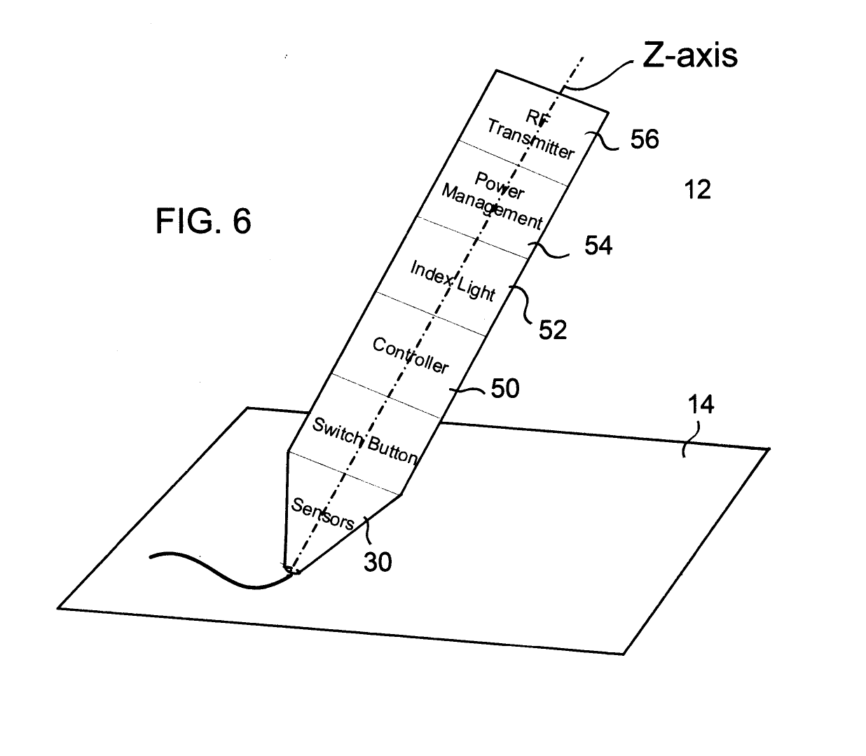

Referring additionally to FIG. 6, a simplified block diagram of pen 12 is illustrated. At the lower end tip portion 30 houses sensors 40 and 44. Above that, button or buttons 47 are coupled to sensors 40 and 44 and to a controller 50 that controls the mode of operation of pen 12 in accordance with the commands entered by button or buttons 47. An index light 52 is electrically coupled to controller 50 and provides a cycle index light, viewable by way of index light ring 34, that represents the mode of operation of pen 12 by light color, flashing, etc. A power management block 54 includes a battery or batteries for the operation of pen 12 and circuitry for recharging the battery as required. An RF transmitter block 56 is at the upper end of pen 12 and is used to communicate with calibrator 16 (see FIG. 1). Power management block 54 also contains circuitry for placing the pen in a sleep mode whenever movement is not occurring, to save and extend battery life.

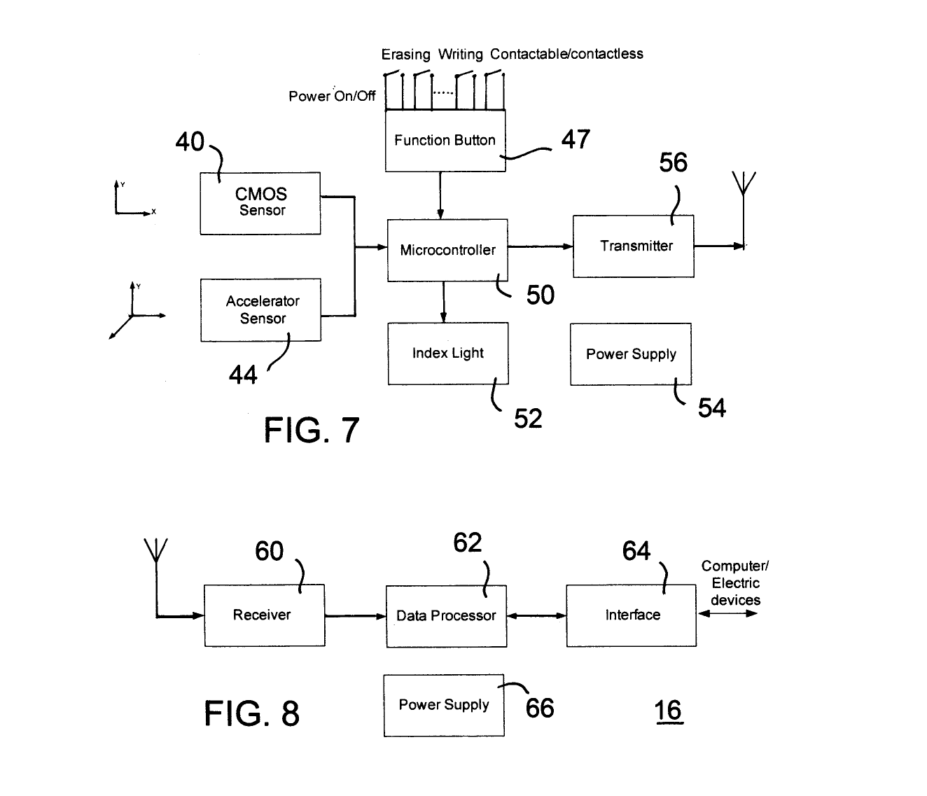

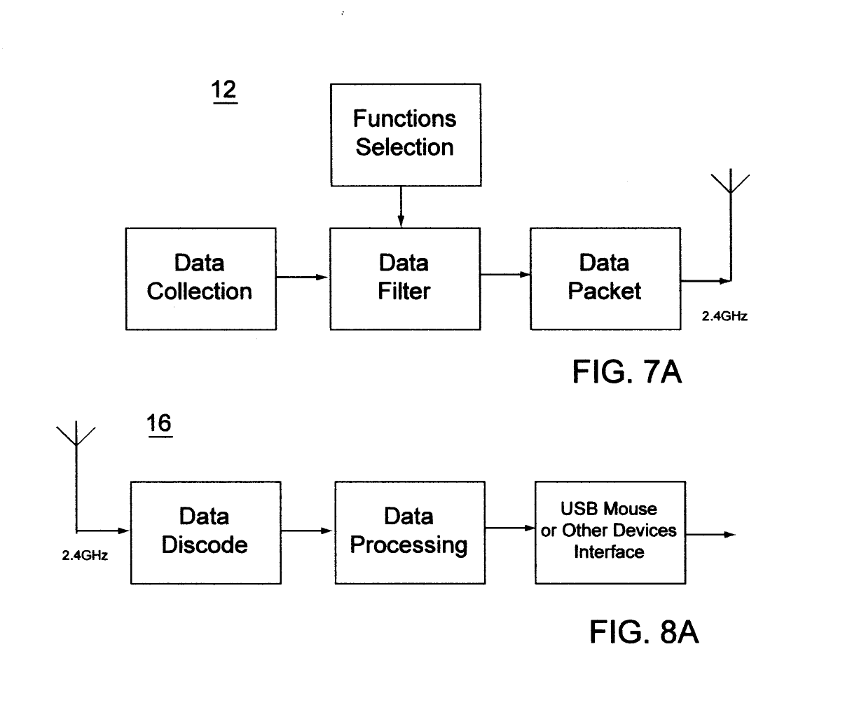

Turning now to FIG. 7, a simplified block diagram of the interconnection of the above described components within pen 12 is illustrated. Controller 50 includes a microcontroller, microprocessor, or the like which is connected to operate under control of mode or function button or buttons 47. Note that several modes of operation are indicated in control of button or buttons 47, including: power ON/OFF (performed by manipulation of cap 35); erasing; writing contactable (e.g. writing in writing surface 14); or writing contactless (writing in a writing space, such as air). Controller 50 receives signals representative of path coordinates from optical sensor 40 and acceleration sensor 44 and converts these coordinates to display parameters that are transmitted to calibrator 16. Here it should be understood that optical sensor 40 is only operative when pen 12 is used on a writing surface, such as writing surface 14. Further optical sensor 40 only provides indications of movement in two-axes, i.e. the X and Y axes in the plane of writing surface 14. Acceleration sensor 44 provides indications of movement in three-axes with one of its purposes being to provide an indication of pen 12 being removed or lifted from writing surface 14. Controller 50 also controls index light 52 (which shows the function setting to the user) and the entire pen 12 is powered by electrical power from power supply 54.

Referring additionally to FIG. 7A, several functions for the various boxes of FIG. 7 are illustrated. As illustrated, CMOS sensor 40 and acceleration sensor 44 of FIG. 7 have the function of data collection, which data is sent to microcontroller 50. Microcontroller 50 injects a time dimension into the sensing operation by determining whether data received from sensors 40 and/or 44 comes within a predetermined time interval. If data is received that is outside the time interval microcontroller 50 automatically determines that the data is not part of the present writing operation. Writing can continue by simply bringing pen 12 back to the writing surface of writing space. Also, microcontroller 50 has the function of filtering received data, to remove vibration noises and the like due to friction between the end of pen 12 and the writing surface, roughness of the writing surface, etc.

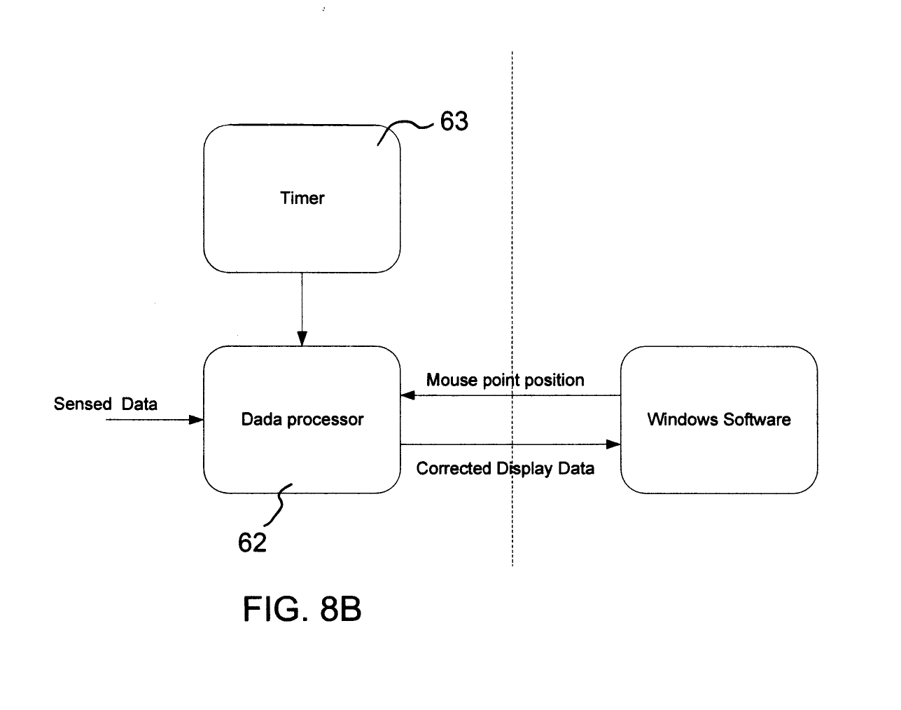

Referring to FIG. 8, a simplified block diagram of calibrator 16 is illustrated. Calibrator 16 includes a receiver 60 tuned to receive signals transmitted by transmitter 56 in pen 12. The received signals are processed in a data processor 62, such as a microcomputer or the like, and sent by way of an interface 64 to whatever computer (e.g. computer 18) and/or other electric devices that are coupled thereto. A power supply 66 supplies power to the components of calibrator 16. In this embodiment, calibrator 16 receives power by way of the connection to computer 18 (e.g. a USB plug or the like) but may be powered by batteries, a plug-in unit, or any other convenient source of power.

Referring additionally to FIG. 8A, several functions for the various boxes of FIG. 8 are illustrated. As illustrated, receiver 60 decodes data received from pen 12 into, for example, an identification code for pen 12, function or mode index according to the mode in which pen 12 is operating, a sensor identification code for sensors 40 and 44, and filtered data. To this end it should be noted that more than one pen 12 can be used in writing system 10 if desired. For example, several people in a discussion or lecture might each have a pen to add information to the discussion. The various pens are differentiated by means of an identification code and data processor 62 automatically coordinates new data from a pen with old data from the same pen.

Data processor 62 has the initial function of setting the display proportion parameters, as explained above. In the contactless writing mode (3D writing) processor 62 receives acceleration signals and calculated position from the signals using a well known process. In the contactable writing mode (2D writing) processor 62 receives CMOS movement signals and acceleration signals (generally these signals are alternative, i.e. on the paper and off the paper or between words, lines, etc.) and calculates position from the signals by comparing new path coordinates to stored display parameters. When signals indicating the erase mode of operation are received, processor 62 automatically switches to white to provide the erase operation. Also, microcontroller 62 automatically provides error calibration, including the posture or orientation of pen 12 to a writing surface of writing space, accumulation or drift error, and vibration and crash errors (e.g. pen 12 is dropped by the user).

Referring additionally to FIG. 8B another function diagram for microprocessor 62 of calibrator 16 is illustrated. In this function microprocessor 62 includes or has coupled thereto a timer 63 to introduce a fourth dimension into received data. Thus, data received from pen 12 is coordinated in accordance with real time to support the ability to generate output signals for slow and fast motion.

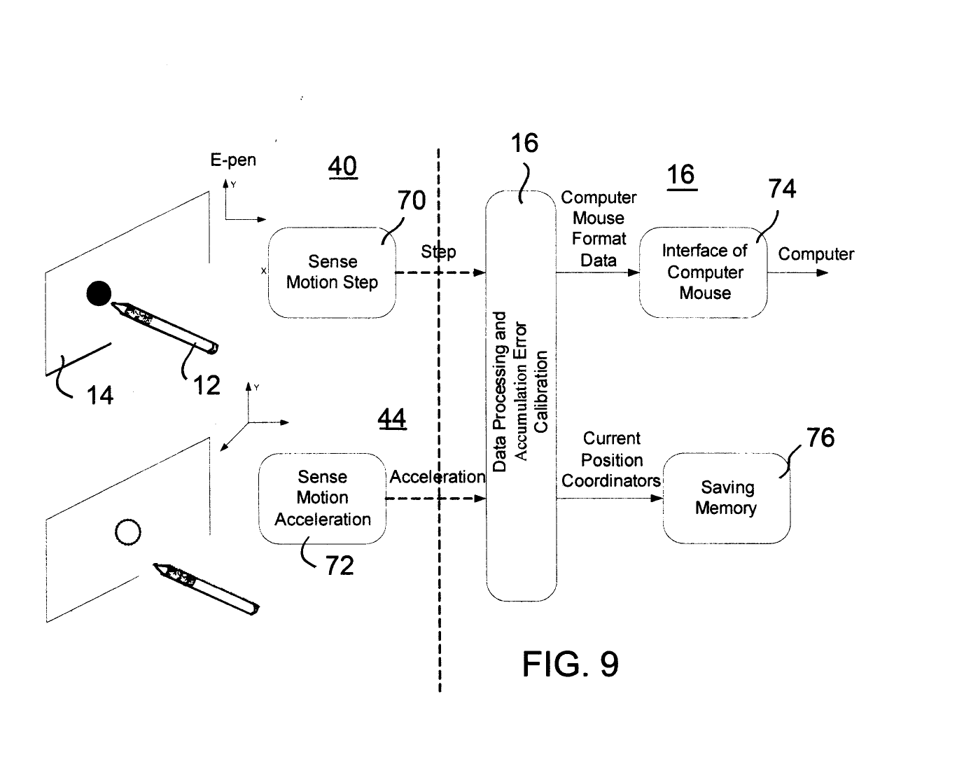

Turning now to FIG. 9, a flow chart illustrating two different functions of writing system 10 is illustrated. In a first function or operating mode, i.e. writing contactable, pen 12 is used for writing on writing surface 14. In this mode of operation optical motion sensor 40 provides the primary motion signals. As described briefly above, optical sensor 40 provides indications of movement in two-axes, i.e. the X and Y axes in the plane of writing surface 14. A block 70 indicates that optical sensor 40, in cooperation with microprocessor 50, senses two-dimensional motion and sends steps indicative of this motion to calibrator 16. Simultaneously, acceleration sensor 44 senses movement in three-axes and sends signals indicative of this movement, represented by a block 72, to calibrator 16. Data processor 62 in calibrator 16 uses these signals to calculate display parameters and sends these parameters to computer 18, for example, by way of the computer mouse interface (represented by block 74).

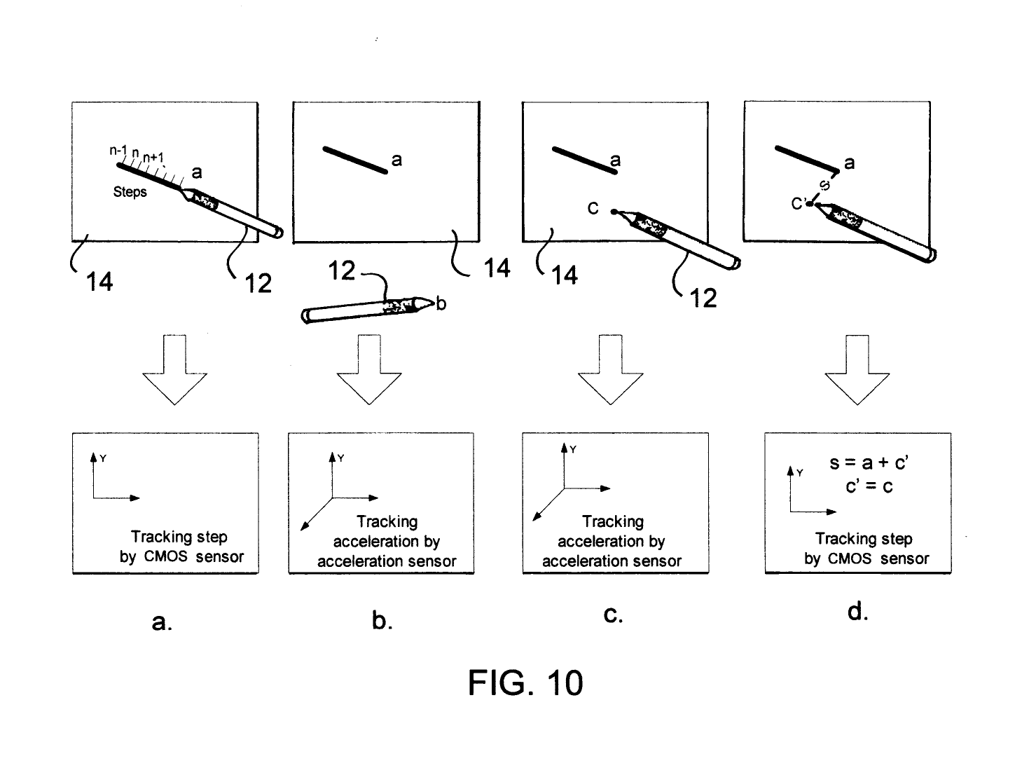

The interaction of optical sensor 40 and acceleration sensor 44 in the operation mode of contactable writing is illustrated in more detail in FIG. 10. In FIG. 10a pen 12 is in contact with writing surface 14 and steps indicative of the two-dimensional movement, sensed by optical sensor 40, are sent to calibrator 16. In FIG. 10b pen 12 is lifted from writing surface 14 as, for example, when traversing from one line to the next or from one word to the next. Indications of this three-dimensional movement, sensed by acceleration sensor 44, are sent to calibrator 16. In FIG. 10c pen 12 is again brought into contact (re-contact) with writing surface 14, which movement is again sensed by acceleration sensor 44 and once writing surface 14 is sensed by optical sensor 40 signals from optical sensor 40 are again sent to calibrator 16, as indicated in FIG. 10d. Thus, calibrator 16 continuously provides current position coordinates to computer 18 and to the memory.

Also, in this mode of operation calibrator 16 uses the motion signals received from the two sensors (blocks 70 and 72) to calculate errors that may occur between sensor signals and accumulate the errors. In general, the optical sensor is more precise than the acceleration sensor and, therefore, the output of the optical sensor is used to correct the out put of the acceleration sensor, with the difference being considered the error signal. From the two sensor signals and the error accumulation, calibrator 16 continually processes current position coordinates of pen 12, which are saved to a memory associated with data processor 62 (indicated by block 76). Also, when pen 12 is lifted away from writing surface 14 (as for example between words, moving to a new line, etc) light received by optical sensor 40 is unfocused, which the CMOS motion sensor and data processor 62 interpret as a lifting of pen 12 from writing surface 14.

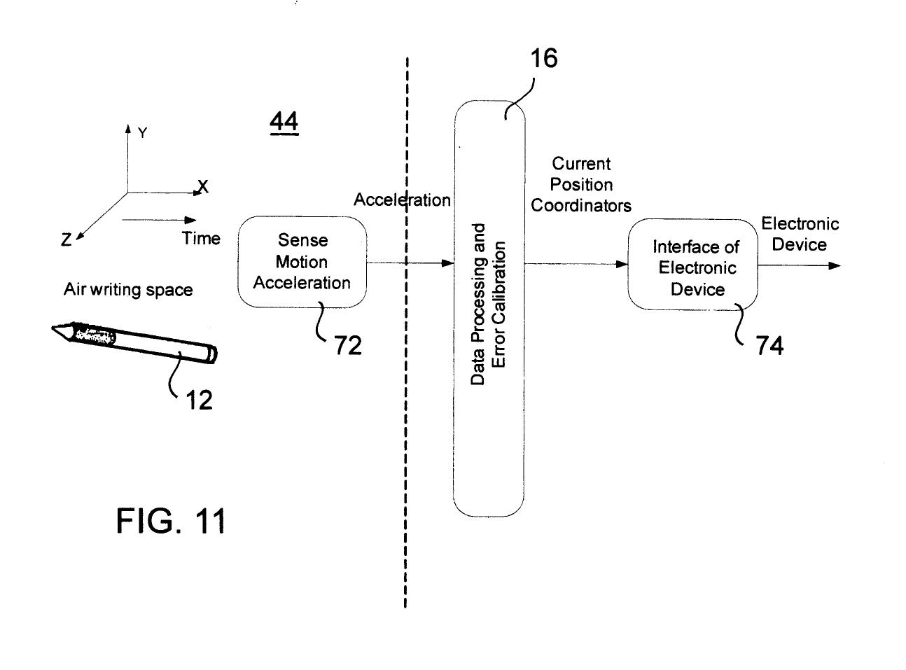

In a second mode of operation, i.e. writing contactless, optical sensor 40 is disengaged or shut-off and the primary movement signals come from acceleration sensor 44. In this mode of operation acceleration sensor 44 senses movement in three-axes and sends signals indicative of this movement, represented by a block 72, to calibrator 16. In a well known process calibrator 16 continually calculates the position of pen 12 and sends coordinates to both computer 18 and the memory. In this fashion a continuous movement path is generated and can be displayed by means of projector 20. A flow diagram illustrating only this mode of operation is illustrated in FIG. 11

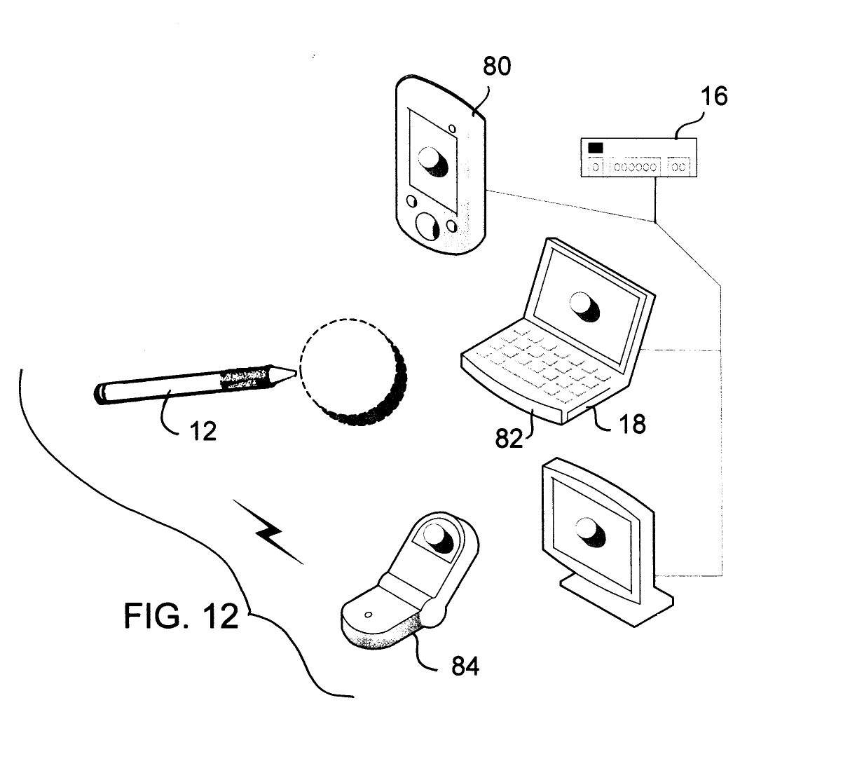

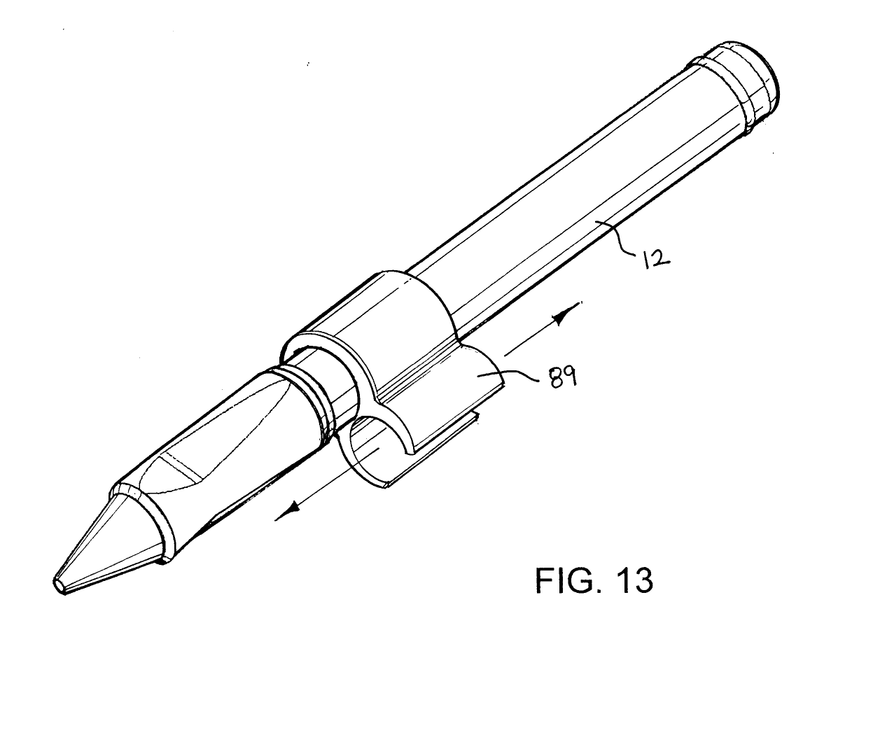

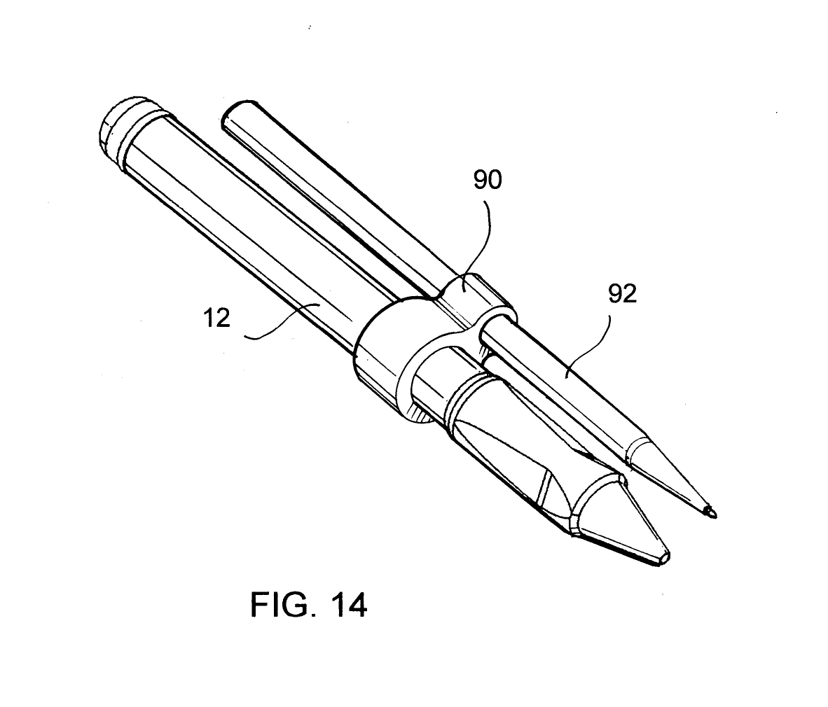

Referring additionally to FIG. 12, several different end-type devices that can be used in conjunction with the contactless writing mode of writing system 10 are illustrated. Examples of end-type devices that can be used to receive display parameter signals from calibrator 16 include: computer 18; a PDA or tablet PC 80; a television 82; a cell phone 84; or any similar type of receiving device with a visual display. Also, FIG. 13 illustrates a mobile finger holder 89 to aid in supporting pen 12 during tracking motions in the contactless writing mode (3D writing). Further, FIG. 14 illustrates apparatus or holding bracket 90 for adding a writing pen 92 (e.g. ink pen, pencil, marker, etc.) to pen 12 to support writing on paper. In this particular embodiment, the user can simply write on paper (or other convenient surface) and pen 12 will track the writing and convey it to a computer or the like in real-time.

Thus, a new and improved electronic writing system has been disclosed that is extremely accurate and highly versatile. The writing system can be used to write on virtually any surface in a contactable mode of operation or in air or space in a contactless mode of operation. Further, the writing system can be used in conjunction with a variety of end-type devices that is display parameters can be transmitted or communicated to virtually any receiving device with a visual display. Further, the display parameters can be saved in memory and used at any time. Also, in the contactless writing mode of operation writing system 10 and especially pen 12 can be used in a variety of different functions (i.e. other than writing) such as video games, etc.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A writing system comprising:
a pen including a two-dimensional optical sensor and a three dimensional acceleration sensor positioned to indicate movement of the pen;
a calibrator coupled to receive path coordinate signals from the two-dimensional optical sensor and the three dimensional acceleration sensor; and
the calibrator and the two-dimensional optical sensor and the three dimensional acceleration sensor configured to operate in one of two modes, a contactable mode of operation wherein both the two-dimensional optical sensor and the three dimensional acceleration sensor supply path coordinate signals to the coordinator and a contactless mode of operation wherein only the three dimensional acceleration sensor supplies path coordinate signals to the coordinator.

2. A writing system as claimed in claim 1 further including a memory coupled to the coordinator and connected to receive display parameters and store current position coordinates.

3. A writing system as claimed in claim 2 wherein the calibrator and the two-dimensional optical sensor and the three dimensional acceleration sensor are further configured to operate in an erase mode.

4. A writing system as claimed in claim 1 wherein the pen further includes a controller coupled to connect the two-dimensional optical sensor and the three dimensional acceleration sensor into either of the two modes.

5. A writing system as claimed in claim 4 wherein the controller is coupled to receive motion signals from the two-dimensional optical sensor and the three dimensional acceleration sensor and convert the motion signals into the path coordinate signals.

6. A writing system as claimed in claim 1 wherein the pen is coupled to the calibrator by a wireless transmission system.

7. A writing system as claimed in claim 1 further including a computer coupled to the calibrator and a projector coupled to the computer.

8. A writing system as claimed in claim 7 wherein the calibrator is programmed to generate display parameters in response to receiving path coordinate signals and to send the display parameters to the computer, the computer is programmed to receive the display parameters and to generate a path followed by the pen and to communicate the path to the projector.

9. A writing system as claimed in claim 8 wherein the writing system is projector is positioned to project a display of the path onto a writing surface in a color other than white.

10. A writing system as claimed in claim 9 wherein the calibrator and the two-dimensional optical sensor and the three dimensional acceleration sensor are configured to operate in one of two modes and the projector is positioned to project a display of the path onto a writing surface in a color other than white.

11. A writing system as claimed in claim 9 wherein the calibrator and the two-dimensional optical sensor and the three dimensional acceleration sensor are configured to operate in an erase mode and the projector is positioned to project a display of the path onto a writing surface in white.

12. A writing system comprising:
a pen including a two-dimensional optical sensor, a three dimensional acceleration sensor, and a controller coupled to the two-dimensional optical sensor and the three dimensional acceleration sensor and configured to convert signals received from the two-dimensional optical sensor and the three dimensional acceleration sensor into path coordinate signals;
a switch coupled to the controller, the switch and controller being configured to provide a contactable mode of operation and a contactless mode of operation, the controller coupled to receive signals from both the two-dimensional optical sensor and the three dimensional acceleration sensor in the contactable mode of operation and to receive signals only from the three dimensional acceleration sensor in the contactless mode of operation; and
a calibrator coupled to receive the path coordinate signals from the controller and to generate display parameters in response thereto.

13. A writing system as claimed in claim 12 wherein the calibrator and the two-dimensional optical sensor and the three dimensional acceleration sensor are further configured to operate in an erase mode.

14. A writing system as claimed in claim 12 wherein the pen is coupled to the calibrator by a wireless transmission system.

15. A method of writing on one of a writing surface and a writing space comprising the steps of:
providing a pen including a two-dimensional optical sensor and a three dimensional acceleration sensor positioned to indicate movement of the pen and a calibrator coupled to receive path coordinate signals from the two-dimensional optical sensor and the three dimensional acceleration sensor; and
coupling the two-dimensional optical sensor, the three dimensional acceleration sensor, and the calibrator into one of a contactable mode of operation in which both the two-dimensional optical sensor and a three dimensional acceleration sensor communicate signals to the calibrator and a contactless mode of operation in which only the three dimensional acceleration sensor communicates signals to the calibrator.

16. A method as claimed in claim 15 including a step of activating the two-dimensional optical sensor and the three dimensional acceleration sensor, writing on a writing surface and transmitting path coordinate signals from the two-dimensional optical sensor and the three dimensional acceleration sensor to the calibrator.

17. A method as claimed in claim 15 including a step of activating only the three dimensional acceleration sensor, writing in a writing space and transmitting path coordinate signals from the three-dimensional acceleration sensor to the calibrator.

18. A method as claimed in claim 15 including a step of coupling the two-dimensional optical sensor, the three dimensional acceleration sensor, and the calibrator into an erase mode.

19. A method as claimed in claim 15 further including a step of generating display parameters in the calibrator from the path coordinate signals, coupling the display parameters to a computer, and generating a display from the display parameters.

20. A method of writing on one of a writing surface and a writing space comprising the steps of:
providing a pen including a two-dimensional optical sensor, a three dimensional acceleration sensor, and a controller coupled to the two-dimensional optical sensor and the three dimensional acceleration sensor and configured to convert signals received from the two-dimensional optical sensor and the three dimensional acceleration sensor into path coordinate signals, a switch coupled to the controller, the switch and controller being configured to provide a contactable mode of operation and a contactless mode of operation, the controller coupled to receive signals from both the two-dimensional optical sensor and the three dimensional acceleration sensor in the contactable mode of operation and to receive signals only from the three dimensional acceleration sensor in the contactless mode of operation, and a calibrator coupled to receive the path coordinate signals from the controller and to generate display parameters in response thereto;
transmitting signals representative of the path coordinates to the calibrator, generating display parameters in the calibrator, and transmitting signals representative of the display parameters to a computer, and
using the computer, generating a display of the pen movement from received signals representative of the display parameters.

21. A method as claimed in claim 20 further including the steps of moving the switch to the contactable mode of operation and moving the pen on a writing surface and using both the two-dimensional optical sensor and the three dimensional acceleration sensor to generate path coordinates.

22. A method as claimed in claim 20 further including the steps of moving the switch to the contactless mode of operation and moving the pen in a writing space and using only the three dimensional acceleration sensor to generate path coordinates.

23. A method as claimed in claim 20 wherein the switch and controller are further configured to provide an erase mode of operation, the method further including a step of operating the switch to couple the two-dimensional optical sensor, the three dimensional acceleration sensor, and the calibrator into the erase mode.

24. A method of writing on a writing surface comprising the steps of:
providing a writing surface;
providing a pen including a two-dimensional optical sensor, a three dimensional acceleration sensor, and a controller coupled to the two-dimensional optical sensor and the three dimensional acceleration sensor and configured to convert signals received from the two-dimensional optical sensor and the three dimensional acceleration sensor into path coordinate signals, the controller coupled to receive signals from both the two-dimensional optical sensor and the three dimensional acceleration sensor in a contactable mode of operation, and a calibrator coupled to receive the path coordinate signals from the controller and to generate display parameters in response thereto, a computer coupled to receive the display parameters and to generate a display in response thereto, and a projector positioned to project a display onto the writing surface;
storing path coordinates representative of a base line on the writing surface in the calibrator, generating display parameters of the base line in the calibrator and sending the generated display parameters of the base line to the computer and generating a display of the base line in the computer;
sending the display of the base line from the computer to the projector and projecting a writing area and a base line onto the writing surface;
initializing the pen by moving the pen along the projection of the base line on the writing surface and generating real time path coordinates in the pen representative of the pen movement along the projection of the base line; and
transmitting signals representative of the real time path coordinates to the calibrator and generating real time display parameters in the calibrator by comparing real time path coordinates to the stored path coordinates, and transmitting signals representative of a difference to the computer.

25. A method as claimed in claim 24 including the steps of:
using the pen, writing on the writing surface;
sensing movement of the pen during the writing with the two-dimensional optical sensor and the three dimensional acceleration sensor and generating writing signals in the pen representative of real time path coordinates of the movement, and coupling the writing signals to the calibrator; and
receiving the writing signals in the calibrator, comparing the writing signals representative of real time path coordinates to stored path coordinates to generate display signals representative of real time display parameters, coupling the display signals to the computer and generating a display of the writing.
